(19) United States
(12) Patent Application Publication
(10) Pub. No.: US 2008/0264716 A1
(43) Pub. Date: Oct. 30, 2008

(54) Acoustic Device With Variable Focal Length

(75) Inventors: Stein Kuiper, Eindhoven (NL); Bernardus Hendrikus Wilhelmus Hendriks, Eindhoven (NL)

Correspondence Address: PHILIPS MEDICAL SYSTEMS;PHILIPS INTELLECTUAL PROPERTY & STANDARDS, P.O. BOX 3003, 22100 BOTHELL EVERETT HIGHWAY, BOTHELL, WA, 98041-3003, US

(73) Assignee: KONINKLIJKE PHILIPS ELECTRONICS N.V., EINDHOVEN (NL)

(21) Appl. No.: 11/569,884

(22) PCT Filed: Jun. 3, 2005
(86) PCT No.: PCT/IB05/51813

§ 371 Date: Dec. 1, 2006

(30) Foreign Application Priority Data
Jun. 7, 2004 (EP) 04300315.1

(51) Int. Cl. G10K 11/30

(52) U.S. Cl. 181/176

(57) ABSTRACT

A device comprises an acoustic lens (100) with a variable focal length and means (12) for directing incoming acoustic waves onto the lens. The acoustic lens comprises a curved boundary between two fluid media (1, 2) in which the acoustic waves have different propagation velocities. Means (5, 6, 7) are provided for applying a force directly onto one of the fluid media (1) so as to induce a displacement of the boundary (M1, M2). Such arrangement of the acoustic lens makes it possible to achieve rapid variations in the focal.

Acoustic waves are useful in many scientific or technical fields, such as medical diagnosis, non-destructive control of mechanical parts and underwater imaging, etc. Acoustic waves allow diagnoses and controls which are complementary to optical observations, because acoustic waves can travel in media that are not transparent to electromagnetic waves.

U.S. Pat. No. 5,305,731 discloses an acoustic wave generator which comprises an acoustic lens with a variable focal length. The focal length may be adjusted so as to focus an acoustic wave onto a part of a body located at a given distance in front of the generator. The acoustic lens comprises two liquid media separated by a disk-shaped movable wall. The peripheral edge of the movable wall is affixed to the inner surface of a vessel containing both liquid media, and a middle part of the movable wall is affixed to a piston. A displacement of the piston causes the focal length of the acoustic lens to vary.

A drawback of such device is that, due to the mass of the piston, the focal length variations are quite slow. In particular, such device is not suitable for applications requiring rapid focusing of an acoustic wave. Moreover, the means for controlling the displacement of the movable wall are complicated, which makes the generator large, heavy and cumbersome.

It is an object of the present invention to provide a device comprising an acoustic lens with a focal length which may be varied rapidly.

The invention provides an acoustic device comprising an acoustic lens with variable focal length and means for directing incoming acoustic waves onto the lens. According to the invention, the acoustic lens comprises two fluid media in which the acoustic waves have different velocities, a boundary between said media, and means for applying a force directly onto at least part of one of the fluid media so as to selectively induce a displacement of at least part of said boundary.

Within the scope of the invention, a displacement of at least part of said boundary includes any change in the position or in the shape of the boundary.

Thus, in a device according to the invention, the displacement of the boundary between the two fluid media of the acoustic lens is controlled via a force acting directly on part of one of the fluid media. Therefore a control system connected to a wall located at the boundary between the two fluid media, such as a piston, is unnecessary. This results in a reduction in the total mass of the movable parts of the lens. As a consequence, the focal length of the acoustic lens may be varied more rapidly.

Moreover, such device can be light and small-sized, so that it can be easily used and handled. In particular, such device can be introduced in small cavities, for example in cavities of a human body.

Another advantage of a device according to the invention results from the shape of the boundary between the two fluid media of the acoustic lens. Indeed, the shape of the boundary may be approximately a portion of a plane or a portion of a sphere. Then the imaging aberrations of the lens are well known, and can be corrected with additional fixed-focus aspheric acoustic lenses. Thus the focusing quality of the lens is very good.

Preferably, the two fluid media have substantially equal densities. Then, the displacement of the part of the boundary is independent on gravitation, and thus independent on the orientation of the acoustic device.

Advantageously, the fluid substances in the acoustic lens may be selected so that the acoustic wave velocity in one of the fluid media is at least 50% higher than in the other fluid medium. Then, an important refractive effect occurs at the boundary between the two fluid media. The power of the acoustic lens, related to the focal length, may thus be adjusted to high values. This results in an important change of the vergence of the acoustic waves upon crossing the boundary. For example, the two fluid media may be based on water and silicone oil, respectively. The velocity of sound in water is about 1,490 m/s and the velocity of sound in silicone oil is about 790 m/s, i.e. 1.9 times lower.

In a first embodiment of the invention, the two fluid media are not miscible with each another, and the boundary is a contact meniscus between the two fluid media. In this case, no wall is placed between both fluid media, resulting in a further reduction in the total mass of the mobile parts of the lens.

In a second embodiment of the invention, the boundary comprises an elastic film. Such film prevents both fluid media from mixing with each another, and it can be stretched by relatively small forces. The lens may also comprise another elastic film, the two elastic films being arranged to hold one of the two fluid media at two respective locations of a path of the acoustic waves. A higher power value of the lens can thus be achieved.

The means for applying the force directly onto at least part of one of the fluid media can be of several types. According to a first type, a first one of the two fluid media comprises a polar and/or electrically conductive liquid substance, and the force applying means comprise an electrode arranged to apply an electric force onto at least part of said first fluid medium. Such means are adapted for electronically controlling the displacement of the boundary. Very rapid variations of the focal length of the acoustic lens can thus be obtained. The electric force is applied advantageously on a part of the first fluid medium which is adjacent the boundary. Then the whole quantity of first fluid medium may be reduced, allowing reductions in the mass and in the size of the device.

According to a second type, the force applying means comprise a movable body contacting said part of the fluid medium. In an optimized embodiment of this type, the movable body comprises a wall of a vessel containing said part of the fluid medium.

The device may be adapted so that the acoustic wave involved in the device is an ultrasonic wave. Then it can be used for any known application involving ultrasonic waves, for example high precision imaging or remote acoustic power delivery.

The device may be designed for imaging an object located outside said device. Then it further comprises an acoustic detector. The means for directing incoming acoustic waves onto the lens may comprise a coupling cushion arranged at an acoustic wave inlet of the device. The image is obtained when an acoustic wave travels from the object to the detector. The acoustic lens is arranged between the detector and the acoustic wave inlet of the device, so as to provide focusing onto a selected part of the object. Varying the focal length allows imaging of different parts of the object located at various distances in front of the imaging device. A more complete visualization of the object is thus possible. Furthermore, moving the imaging device is easier, because the imaging device is small-sized, more simple and less cumbersome than those already existing. Such acoustic imaging devices are useful for many applications, because they provide a non-destructive visualization method. They are useful for medical purposes or for material control, for example for checking whether a body is free of cracks. Using of an acoustic wave of ultrasonic type further provides a higher resolution, due to the short wavelengths involved.

The device may alternatively be designed for transmitting an acoustic wave towards an object located outside said device. Then, it further comprises an acoustic generator. The acoustic lens is arranged between the generator and an acoustic wave outlet of the device, so as to provide focusing of the transmitted acoustic wave onto a selected part of the object. The means for directing incoming acoustic waves onto the lens are located between the acoustic generator and the lens. These means may consist in a coupling fluid medium contacting both the generator and the lens, for example. Such device may be used, e.g. in lithotripsy applications.

These and other aspects of the invention will become apparent from the non-limiting embodiments described hereafter in reference to the following drawings:

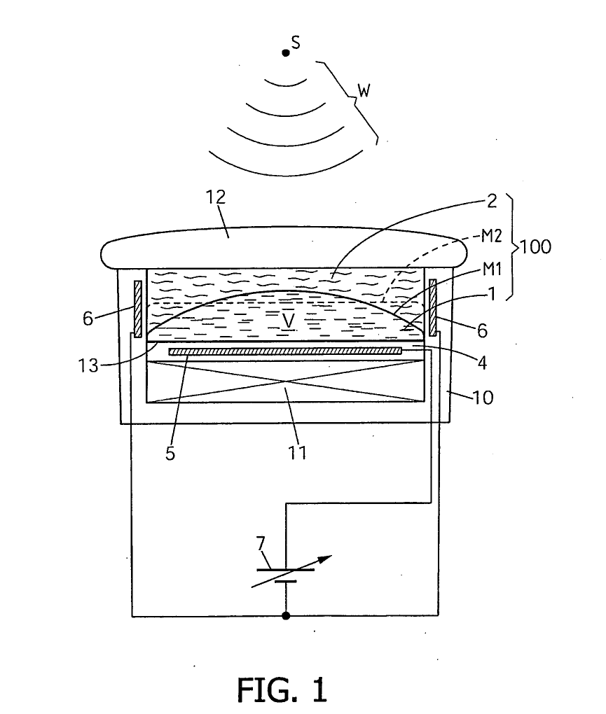

FIG. 1 is a schematic sectional view of an ultrasonic probe according to a first embodiment of the invention; and

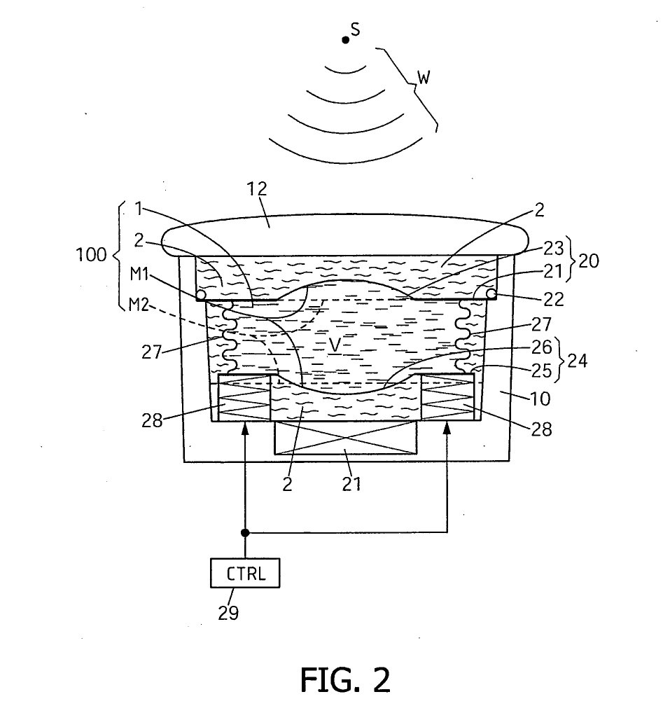

FIG. 2 is a schematic sectional view of an ultrasonic source according to a second embodiment of the invention.

In theses figures, same numbers refer to similar elements, or to elements with similar function. Furthermore, for clarity reason, the sizes of the represented elements do not correspond to sizes of real elements.

The ultrasonic probe shown in FIG. 1 has a housing 10 made of electrically insulating material. The housing 10 may be of cylindrical shape, for example. It has an open top end and a closed bottom end. An acoustic detector 11 is placed within the housing 10, close to the bottom end. The detector 11 is of a type well known in the art of acoustic waves. The sensing face of the detector 11 is oriented upwards, i.e. towards the open end of the housing 10.

A coupling cushion 12 is adapted to the open end of the housing 10 so as to define together with the housing 10 a sealed volume V between the detector 11 and the cushion 12. The volume V is for example about 3 cm in diameter, and about 1.5 cm in height, i.e. along the axis of the housing 10. The coupling cushion 12 is made up of a flexible sealed pocket filled with a liquid substance such as water. It is designed for developing a large contact area when pressed against a body, such as a human body.

The volume V is filled with two liquid media numbered 1 and 2 respectively. Liquid medium 1 preferably consists primarily of water. It is for example a salt solution, with ionic contents high enough to have an electrically polar behavior, or to be electrically conductive. Liquid medium 1 may contain potassium and chloride ions, both with concentrations of 1 mol.l⁻¹, for example. Alternatively, it may be a mixture of water and ethyl alcohol. Liquid medium 2 is for example made of silicone oil, that is insensitive to electric fields.

Liquid media 1 and 2 are not miscible with each another. Thus they always remain as separate liquid phases in the volume V. The separation between the liquid media 1 and 2 is a contact surface or meniscus which defines a boundary without any solid part.

A fixed wall 4 is located between the volume V and the detector 11, close to the sensing face of the detector 11. The wall 4 is transparent to the acoustic waves, and a coupling material may be inserted between the wall 4 and the detector 11. A film of polyethylene may form the wall 4 for example. The wall 4 bears an electrode 5 which may be in the form of a disk with a diameter approximately equal to the inner diameter of the housing 10. Electrode 5 may be electrically insulated from liquid medium 1. Then it is coupled capacitively with the liquid medium 1. In alternative embodiments, the electrode 5 may be in contact with the liquid medium 1.

The wall 4 is preferably coated with a hydrophilic coating 13, so as to maintain the liquid medium 1 near the electrode 5. Likewise, the cushion 12 may be coated in the volume V with a hydrophobic material (or water-repellent material) in order to maintain the liquid medium 2 in the upper part of the volume V. Thus the respective positions of the liquid media 1 and 2 remain unchanged when moving the probe, even upside down. Both liquids have substantially equal densities in order to make the interface between the liquid media 1 and 2 independent on gravitation and thus on the orientation of the probe.

The cushion 12, the liquid media 1 and 2, and the wall 4 form a guide for an acoustic wave W originating from a source point S located on the axis of the probe and distant from the cushion 12. The cushion 12 forms the inlet to the probe for the wave W, and the wave W travels within the probe towards the sensing face of the detector 11.

A second electrode 6 is located in the lateral wall of the housing 10. Electrode 6 may have a cylindrical shape and surrounds the volume V. Electrode 6 is electrically insulated from electrode 5 and from liquid medium 1. Electrodes 5 and 6 are connected to two outputs of an adjustable voltage supply source 7.

When the voltage supplied by the source 7 is zero, then the contact surface between the liquid media 1 and 2 is a meniscus M1. In a known manner, the shape of the meniscus is determined by the surface properties of the inner side of the lateral wall of the housing 10: its shape is then approximately a portion of a sphere, especially for the case of equal densities of both liquid media 1 and 2. Because the acoustic wave W has different propagation velocities in the liquid media 1 and 2, the volume V filled with the liquid media 1 and 2 acts as a convergent lens 100 on the acoustic wave W. Thus, the divergence of the acoustic wave W entering the probe is reduced upon crossing the contact surface between the liquid media 1 and 2. The focal length of the lens 100 is the distance from the detector 11 to a source point of the acoustic wave, such that the acoustic wave is made planar by the lens 100 before impinging on the detector 11.

When the voltage supplied by the source 7 is set to a positive or negative value, then the shape of the meniscus is altered, due to the electrical field between the electrodes 5 and 6. In particular, a force is applied on the part of the liquid medium 1 adjacent the contact surface between the liquid media 1 and 2. Because of the polar behavior of liquid medium 1, it tends to move closer to the electrode 6, so that the contact surface between the liquid media 1 and 2 flattens. In the figure, M2 denotes the shape of the contact surface when the voltage is set to a non-zero value. Such electrically controlled change in the form of the contact surface is called electrowetting. In case liquid medium 1 is electrically conductive, the change in the shape of the contact surface between the liquid media 1 and 2 when voltage is applied is the same as previously described.

Because of the flattening of the contact surface, the focal length of the lens 100 is increased when the voltage is non-zero. For example, when the voltage supplied by the source 7 is set at about 100 volts, the focal length is about 20 cm.

The probe just described is advantageously combined with an ultrasonic generator within the same device. Therefore, the detected acoustic wave is a reflected part of an ultrasonic wave transmitted by the generator to an external body in contact with the cushion 12. In a known manner, the detection signal supplied by the detector 11 allows identification of the type of the material located at the focus S, together with material properties such as sound velocity, density, hardness, speed of the liquid medium through Doppler effect, etc.

According to general imaging principles, the resolution of an imaging system is increased when increasing the size of the elements transmitting the waves. Therefore, the resolution of the previously described ultrasonic imaging device may be increased by using a lens with variable focal length having a larger diameter. But stability problems occur when the contact surface between the liquid media is too wide. A solution for increasing the diameter of the variable lens is to use a Fresnel-type lens. A Fresnel-type lens is divided into several parts, each part having the same refraction effect as a corresponding portion of an usual lens, but having a reduced thickness. Electrowetting may be used for controlling the shape of the contact surface between two liquid media in each part of the Fresnel-type lens. A Fresnel-type lens with a variable focal length is thus obtained.

Turning to FIG. 2, an ultrasonic source is now described. Reference 10 still refers to a housing with a closed lower end and an open upper end. The upper end is covered with a coupling cushion 12 similar to that previously described.

An ultrasonic generator 21 is located in the housing 10, against the bottom end. V is the volume between the generator 21 and the cushion 12. The cushion 12 forms an outlet of the source for an ultrasonic wave W produced by the generator 21.

The volume V is divided with a fixed wall 20 into an upper part and a lower part. The wall 20 comprises a rigid disk 21 which is maintained against an inner shoulder of the housing 10 with a sealing ring 22 therebetween. The disk 21 has a circular opening in its central part, of about 4-5 cm in diameter. The opening is closed with a resilient film 23, for example a rubber film. In rest configuration, the film 23 is substantially planar. The upper part of the volume V between the cushion 12 and the wall 20 is filled with a liquid medium 2.

A movable wall 24 is arranged in the lower part of the volume V, between the fixed wall 20 and the generator 21. The wall 24 comprises a rigid disk 25. The disk 25 has a peripheral diameter smaller than the inner diameter of the housing 10, so that it can move up and down, i.e. along a direction parallel to the axis of the housing 10. The disk 25 has a circular opening in its central part, with a diameter approximately equal to the diameter of the opening of the disk 21. The opening of the disk 25 is closed with a film 26 which may be identical to the film 23. Peripheral bellows 27 connect both disks 21 and 25, so as to define a sealed vessel together with the walls 20 and 24 in the lower part of the volume V. Several actuators 28, for example four piezoelectric actuators, are arranged between the bottom end of the housing 10 and the disk 25. The actuators 28 are connected to a controller 29, so as to control the position of the mobile wall 24.

The vessel defined by the walls 20 and 24 together with the bellows 27 contains a liquid medium 1. Liquid medium 2 also fills the gap between the generator 21 and the movable wall 24 in order to direct onto the lens the acoustic waves output by the generator 21. The part of the liquid medium 2 located in this gap is hydrostatically coupled with the part of the liquid medium 2 located above the fixed wall 20. This coupling may be achieved by providing holes in the disk 21 outside the bellows 27 for example. Liquid media 1 and 2 are selected so that the ultrasonic waves have different propagation velocities in each liquid medium. As previously, liquid medium 1 may be based on water, while liquid medium 2 may be silicone oil.

When the movable wall 24 is in the rest position, i.e. in a lower position, both films 23 and 26 are planar (M2 in FIG. 2), so that the vergence of an ultrasonic wave W produced by the generator 21 is unchanged when traveling through the vessel containing liquid medium 1.

When the movable wall 24 is pushed upwards by the actuators 28, the volume filled with the liquid medium 1 remains constant because the liquid medium 1 is incompressible. The pressure in the liquid medium 1 becomes higher than the pressure in the liquid medium 2, so that both resilient films 23 and 26 are stretched outwards by the liquid medium 1. The respective shapes of the films 23 and 26 become spherical portions (M1 in FIG. 2). A lens 100 is thus obtained. The generator 21 produces a planar ultrasonic wave W. After having crossed the two films 23 and 26, the ultrasonic wave W is convergent, with a focus point S located outside the source, at a distance which depends on the curvatures of the films 23 and 26. Adjusting the position of the movable wall 24 with the controller 29 results in varying the curvatures of the films, and thus results in a variation in the focus length of the source.

Although the source has been described with two resilient films, it is clear that a single resilient film is sufficient for forming a lens with a variable focal length.

It is also possible to combine lens effects respectively obtained with boundaries between two liquid media as formed in the first and the second embodiments described above. Many other modifications may be implemented, without departing from the concept of acting directly onto at least one of the liquid media for varying the shape of the boundary.

Another option is to combine a system with a direct contact surface between two liquid media as in the first embodiment with a movable part contacting at least one of the two liquid media. The contact with the movable part may also be combined with electrodes arranged as in the second embodiment.

1. Acoustic device comprising an acoustic lens with variable focal length and an acoustic wave director for directing incoming acoustic waves onto the lens, wherein the acoustic lens comprises two fluid media in which the acoustic waves have different velocities, a boundary between said media, and an electric control for applying a force directly onto at least part of one of the fluid media so as to selectively induce a displacement of at least part of said boundary.

2. Acoustic device according to claim 1, wherein the two fluid media have substantially equal densities.

3. Acoustic device according to claim 1 or 2, wherein the acoustic wave velocity in one of the fluid media is at least 50% higher than in the other fluid medium.

4. Acoustic device according to claim 1, wherein the two fluid media are based on water and silicone oil, respectively.

5. Acoustic device according to claim 1, wherein the two fluid media are not miscible with each another, and wherein said boundary is a contact meniscus between the two fluid media.

6. Acoustic device according to claim 5, wherein said acoustic lens is of the Fresnel-type.

7. Acoustic device according to claim 1, wherein said boundary comprises an elastic film.

8. Acoustic device according to claim 7, further comprising another elastic film, wherein the elastic films are arranged to hold one of the two fluid media at two respective locations of a path of the acoustic waves.

9. Acoustic device according to claim 1, wherein a first one of the two fluid media comprises a polar or electrically conductive liquid substance, and wherein the force applying means comprise an electrode arranged to apply an electric force onto at least part of said first fluid medium.

10. Acoustic device according to claim 9, wherein the electrode is arranged to apply the electric force on a part of said first fluid medium adjacent the boundary.

11. Acoustic device according to claim 1, wherein the electric control further comprises a movable body contacting said part of the fluid medium.

12. Acoustic device according to claim 11, wherein the movable body comprises a wall of a vessel containing said part of the fluid medium.

13. Acoustic device according to claim 1, wherein the acoustic lens operates in the ultrasonic wavelength range.

14. Acoustic device according to claim 1, further comprising an acoustic detector, the acoustic lens being located between the acoustic wave director and the detector, in order to focus on the detector acoustic waves received from an imaged object, located outside said device, through the acoustic wave director.

15. Acoustic device according to claim 1, further comprising an acoustic generator, the acoustic wave director being located between the generator and the acoustic lens in order to transmit an acoustic wave produced by the generator towards an object located outside said device.
